(19) United States
(12) Patent Application Publication
(10) Pub. No.: US 2021/0115353 A1
(43) Pub. Date: Apr. 22, 2021

(54) PROCESS FOR ENRICHMENT OF CAROTENOIDS IN A FATTY ACID COMPOSITION

(71) Applicant: VISIONARY FIBER TECHNOLOGIES, INC., Lockhart, TX (US)

(72) Inventors: Scott DAVIS, Smithville, TX (US); Matthew MOORE, Austin, TX (US); Pulinkumar N. PATEL, San Marcos, TX (US)

(21) Appl. No.: 17/252,874

(22) PCT Filed: Mar. 27, 2020
(86) PCT No.: PCT/US2020/025234

§ 371 Date: Dec. 16, 2020

Related U.S. Application Data
(60) Provisional application No. 62/824,785, filed on Mar. 27, 2019.

(51) Int. Cl. C11B 3/00; C11B 3/04; A23K 10/38; A23K 20/158; A23K 40/00; A23K 20/179

(52) U.S. Cl. CPC C11B 3/008; C11B 3/04; C11B 3/001; A23K 20/179; A23K 20/158; A23K 40/00; A23K 10/38

(57) ABSTRACT

A method for producing a carotenoid enriched fatty acid composition includes: reacting an oil including free fatty acids and carotenoids with a basic solution; withdrawing, separately from the oil, an extraction solution including at least a portion of the free fatty acids, at least a portion of the carotenoids, and the basic solution; acidifying the extraction solution to produce an aqueous phase and a fatty acid phase, the fatty acid phase including the free fatty acids and the carotenoids of the extraction solution; and separating the fatty acid phase from the aqueous phase.

### CROSS-REFERENCE TO RELATED APPLICATIONS

This application claims priority to U.S. Provisional Application No. 62/824,785 filed Mar. 27, 2019, the contents of which are herein incorporated in their entirety.

### TECHNICAL FIELD OF THE DISCLOSURE

The present disclosure generally relates to the enrichment of carotenoids in a fatty acid feedstock. More particularly, the disclosure relates to contacting an oil phase containing free fatty acids and carotenoids with a caustic phase within a fiber conduit contactor, thereby effectively partitioning the free fatty acid metal salts and carotenoids out of the oil phase into an aqueous extraction solution, and then neutralizing the extraction solution with an acid to reform and partition the free fatty acids enriched with carotenoids. The net result is a fast, scalable, efficient separation of carotenoids in a free fatty acid matrix derived from crude vegetable oils.

### BACKGROUND OF THE DISCLOSURE

The desire to diversify the value-added co-products from the distillation of corn ethanol cannot be understated. As a byproduct of ethanol distillation, refineries produce oils from the feedstock, e.g., a corn feedstock results in corn oil being produced as a byproduct. The post fermentation oil, also known as distiller's corn oil (“DCO”) when a corn feedstock is employed, is regularly sold at a marginal price as feed for livestock or as feedstock for biodiesel synthesis. However, the DCO can be purified to a food grade oil and sold at a much high price. Among the steps involved in the purification of DCO for human consumption, the removal of free fatty acids (“FFAs”) is paramount. The fermentation process may result in an FFA level over 15% by weight. These FFA levels can be readily reduced to below 1% through the use of fiber conduit contactors, e.g., as described in U.S. Pat. Nos. 7,618,544 and 8,128,825, both of which are incorporated herein in their entireties.

However, it was herein found that upon the extraction of FFAs from DCO using a caustic alcoholic aqueous solution, appreciable co-extraction of the color-bodies present in the crude DCO could be directly visualized as the extracted FFA solution becomes strongly colored. Without being bound by theory, it is believed that the only source for this color should be the carotenoid pigments (also referred to herein as “carotenoids” and including molecules such as α-carotene, β-carotene, canthaxanthin, β-cryptoxanthin, lutein, phytoene and zeaxanthin), which can exist as high as 400 mg/kg (ppm) in DCO. These carotenoids are desirable as natural food pigments and for use in animal feeds. In general, dried distiller's grains (“DDGs”, also a byproduct of ethanol distillation) that are sent to be used as livestock feed are required to have a minimum level of fat (or energy), so the animals will have the appropriate nutrition. The animal feed is regularly enriched with vitamins and minerals to ensure a healthy diet. Furthermore, reports of carotenoid pigments improving desirability in the appearance of egg yolks, meats, and other animal products have created a demand for carotenoid enrichment of livestock feeds.

However, previous attempts to efficiently extract these pigments have been unsuccessful and/or uneconomical. This is due, in part, to the relatively low concentration of carotenoids within DCO. Further, the few reported methods of carotenoid isolation generally involve extraction using a solid phase (e.g., bentonite clay, silica, alumina, polymers, etc.) to remove the carotenoid pigments from DCO. These solid-phase extractants are effective at the decolorization of DCO (i.e., removal of the carotenoid pigments), however, it is challenging to remove the FFAs and carotenoids in one step. As such, there remains a need for a low-cost, efficient process for yielding a neutral oil and a high-concentration carotenoid product.

### SUMMARY OF THE DISCLOSURE

The present disclosure involves the use of a fiber conduit contactor to reduce the levels of FFAs and carotenoids in a feedstock oil containing FFAs and carotenoids, such as DCO. During the processing of the feedstock oil, FFAs and carotenoids are removed and extracted into a caustic solution having a pH of greater than 7 to yield an extraction solution. The extraction solution is then neutralized with acid to produce an aqueous phase and a fatty acid phase, the fatty acid phase containing the extracted FFAs and carotenoids.

In embodiments of the present disclosure, due to the immiscible nature of the feedstock oil and caustic solution, one method of reacting these components includes creating dispersions of one phase in the other to generate small droplets with a large surface area where mass transfer and reaction can occur. After mixing the reactants, separation of the phases is needed for product purity and quality. However, when using dispersion methods, separation of phases can be difficult and time consuming. Accordingly, in embodiments of the present disclosure, a fiber conduit contactor is employed to provide increased surface area to facilitate reaction between the immiscible liquids while avoiding agitation of the immiscible liquids and the resultant formation of dispersions/emulsions that are difficult to separate.

After the FFAs and carotenoids have been removed into the extraction solution, neutralization (i.e., acidification) may be achieved by simply mixing the extraction solution and an acid or acidifying agent. The acidification results in two, easily separable phases: the aqueous phase and the fatty acid phase. The FFAs in the extraction solution are in the form of fatty acid salts (soap) and are therefore dissolved in the aqueous extraction solution. However, upon acidification, the FFAs become immiscible with the aqueous phase. Further, the carotenoids remain primarily dissolved in the fatty acid phase due to their high lipophilicity.

The isolation of carotenoid pigments through a fiber conduit contactor process as described herein allows for the re-introduction of isolated FFAs with highly-enriched carotenoid content (i.e., the fatty acid phase) to the DDGs or other animal feeds to provide an enriched animal feed. This process increases the value of the DCO (via purification thereof) and the animal feed (through enrichment with carotenoid-containing FFAs), thereby yielding increased profitability. Further, embodiments of the method involve a continuous process with a minimal number of discrete steps.

In addition, the presence of very high concentrations of carotenoids in the fatty acid phase may also allow for existing technologies for carotenoid purification to become economically viable. Such technologies have yet been unprofitable for extracting carotenoids from dilute solutions, such as DCO. An example of a carotenoid extraction process is described in U.S. Patent Application Publication No. 2016/0083766, which is incorporated by reference in its entirety. Moreover, the method of the present disclosure allows for the direct enrichment of a co-product that is already being produced by an ethanol refinery.

### BRIEF SUMMARY OF THE DRAWINGS

FIG. 1 is a diagrammatic illustration of a fiber conduit contactor used in an embodiment of the present disclosure.

FIG. 2 is a photograph of a two-phase composition prepared in Example 1 including neutralized distiller's corn oil in the top phase and a carotenoid enriched aqueous phase containing fatty acid soap in the bottom phase.

FIG. 3 is a photograph of a two-phase composition prepared in Example 1 including an aqueous bottom phase and a carotenoid enriched FFA top phase.

FIG. 4 is a diagrammatic illustration of a method for producing a carotenoid enriched fatty acid composition according to an embodiment of the present disclosure.

### DETAILED DESCRIPTION

The following disclosure provides many different embodiments or examples. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

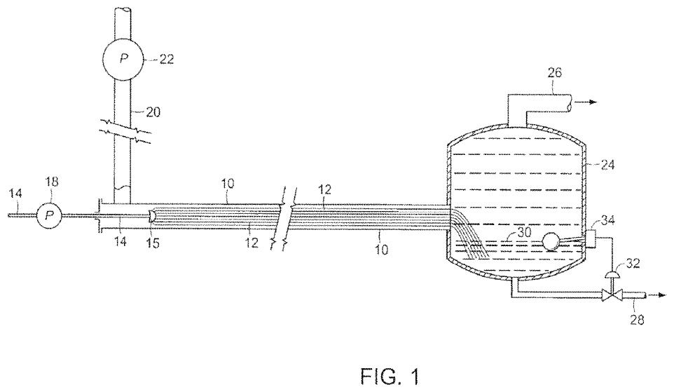

Referring to FIG. 1, a fiber conduit contactor may include a conduit 10 having a bundle of elongated fibers 12 within the conduit 10 for a portion of its length. Fibers 12 are secured to tube 14 at node 15. Tube 14 extends beyond one end of conduit 10 and is operatively associated with metering pump 18 which pumps a first (constrained) phase liquid through tube 14 and onto fibers 12. Operatively connected to conduit 10 upstream of node 15 is inlet pipe 20 which is operatively associated with metering pump 22. This pump 22 supplies a second (continuous) phase liquid through inlet pipe 20 and into conduit 10, where it is squeezed between the constrained coated fibers 12. At the downstream end of conduit 10 is a gravity separator or settling tank 24 into which the downstream end of fibers 12 may extend. Operatively associated with an upper portion of gravity separator 24 is outlet line 26 for outlet of one of the liquids, and operatively associated with a lower portion of gravity separator 24 is outlet line 28 for outlet of the other liquid, with the level of interface 30 existing between the two liquids being controlled by valve 32, operatively associated with outlet line 28 and adapted to act in response to a liquid level controller indicated generally by numeral 34.

Although the fiber conduit contactor shown in FIG. 1 is arranged such that fluid flow traverses in a horizontal manner, the arrangement of the fiber conduit contactor is not so limited. In some cases, the fiber conduit contactor may be arranged such that inlet pipes 14 and 20 as well as node 15 occupy an upper portion of the apparatus and settling tank 24 occupies the bottom portion of the apparatus. For example, the fiber conduit contactor shown in FIG. 1 may be rotated approximately 90° in parallel with the plane of the paper to arrange inlet pipes 14 and 20, node 15 and settling tank 24 in the noted upper and lower positions. Such an arrangement may capitalize on gravity forces to aid in propelling fluid through the contactor. In yet other embodiments, the fiber conduit contactor depicted in FIG. 1 may be rotated approximately 90° in the opposite direction parallel with the plane of the paper such that inlet pipes 14 and 20 and node 15 occupies the bottom portion of the apparatus and settling tank 24 occupies the upper portion of the apparatus. In such cases, the hydrophilicity, surface tension, and repulsion of the continuous phase fluid will keep the constrained phase fluid constrained to the fibers regardless of whether the fluids are flowing up, down, or sideways and, thus, sufficient contact can be attained to affect the desired reaction and/or extraction without the need to counter gravity forces. It is noted that such an inverted arrangement of a fiber conduit contactor is applicable for any of the extraction processes described herein as well as any other type of fluid contact process that may be performed in a fiber conduit contactor. It is further noted that fiber conduit contactors may be arranged in a slanted position for any of the extraction processes described herein or for any other process that may be performed in a fiber conduit contactor (i.e., the sidewalls of the fiber conduit contactor may be arranged at any angle between 0° and 90° relative to a floor of a room in which the fiber conduit contactor is arranged).

During operation, a constrained phase containing an extractant (also referred to herein as a caustic phase) can be introduced through tube 14 and onto fibers 12. Another liquid (a continuous phase) can be introduced into conduit 10 through inlet pipe 20 and through void spaces between fibers 12. Fibers 12 will be wetted by the constrained phase preferentially to the other liquid. The constrained phase will form a film on fibers 12, and the other liquid will flow therethrough. Due to the relative movement of the other liquid with respect to the constrained phase film on fibers 12, a new interfacial boundary between the other liquid phase and the extractant within the constrained phase is continuously being formed, and as a result, fresh liquid is brought in contact with the extractant, thus causing and accelerating the extraction through unprecedented surface contact between the two reacting immiscible phases.

In embodiments of the present disclosure, the constrained phase is composed of a caustic reagent dissolved in a co-solvent aqueous mixture. The co-solvent mixture is composed of water and one or more alcohols, the composition ratio of which is targeted to affect the selective partitioning of individual carotenoids. The alcohol may include one or more of methanol, ethanol, n-propanol, isopropanol, n-butanol, isobutanol, 2-butanol, and tert-butanol. In some embodiments, the constrained phase includes alcohol in an amount of at least 5 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, at least 95 wt %, or 100 wt %. In some embodiments, the alcohol includes a mixture of ethanol and methanol.

The caustic reagent may include one or more basic compounds. Basic compounds may include, e.g., sodium hydroxide and/or potassium hydroxide. In some embodiments, based on the total weight of the constrained phase, the caustic reagent may constitute 0 to 5 wt %. For example, the caustic reagent may be present in a range defined by any of the following upper and lower limits: at least 0.1 wt %, at least 0.25 wt %, at least 0.5 wt %, at least 0.75 wt %, at least 1.25 wt %, at least 1.5 wt %, at least 1.75 wt %, at least 2 wt %, at least 2.25 wt %, at least 2.5 wt %, at least 2.75 wt %, at least 3 wt %, at least 3.25 wt %, at least 3.5 wt %, at least 3.75 wt %, at least 4 wt %, at least 4.25 wt %, at least 4.5 wt %, at least 4.75 wt %, at most 0.5 wt %, at most 0.75 wt %, at most 1.25 wt %, at most 1.5 wt %, at most 1.75 wt %, at most 2 wt %, at most 2.25 wt %, at most 2.5 wt %, at most 2.75 wt %, at most 3 wt %, at most 3.25 wt %, at most 3.5 wt %, at most 3.75 wt %, at most 4 wt %, at most 4.25 wt %, at most 4.5 wt %, and/or at most 4.75 wt %. The pH of the caustic phase is greater than 7.0, e.g., 7-14, 7-13, 8-12, greater than 7.5, greater than 8.0, greater than 8.5, greater than 9.0, greater than 9.5, greater than 10.0, greater than 10.5, greater than 11.0, greater than 11.5, greater than 12.0, greater than 12.5, greater than 13.0, or greater than 13.5.

The feedstock oil constitutes the continuous phase and is not particularly limited except that the feedstock oil includes FFAs and carotenoids. The feedstock oil may include, e.g., vegetable oils, or a combination of vegetable oils and animal oils. Non-limiting examples of vegetable oils include corn oil, palm oil, cottonseed oil, frying oil, etc. The content of carotenoids in the feedstock oil is not particularly limited. In some embodiments, the feedstock oil has a carotenoid content, based on a total weight of the feedstock oil, of at least 10 ppm, at least 50 ppm, at least 75 ppm, at least 100 ppm, at least 125 ppm, at least 150 ppm, at least 175 ppm, at least 200 ppm, at least 225 ppm, at least 250 ppm, at least 275 ppm, at least 300 ppm, at least 325 ppm, at least 350 ppm, at least 375 ppm, at least 400 ppm, at least 425 ppm, at least 450 ppm, at least 475 ppm, at least 500 ppm, at least 525 ppm, at least 550 ppm, at least 575 ppm, at least 600 ppm, 10-600 ppm, 50-500 ppm, 100-400 ppm, or 200-400 ppm.

In any embodiment, the feedstock oil described above may constitute the constrained phase and the extractant described above may constitute the continuous phase. In one or more embodiments, the feedstock oil and the extractant may be simultaneously introduced into the fiber conduit contactor such that a mixture thereof is constrained to the fibers and a mixture thereof flows between the fibers (i.e., the mixture constitutes both the constrained and continuous phases).

During the reaction between the feedstock oil and the caustic phase, at least some of the carotenoids present in the feedstock oil are removed into the caustic phase (i.e., into the “extraction solution”). In any embodiment, a wide variety of carotenoids may be removed from the feedstock oil by the present method. Without being bound by theory, it is believed that the slightly more polar zeaxanthin and cryptoxanthin derivatives (zeaxanthin, β-cryptoxanthin, canthaxanthin and lutein) are among the most likely carotenoids to be removed into the extraction solution.

In any embodiment, the content of FFAs in the feedstock oil may be, e.g., 20 wt % or less, 15 wt % or less, 12 wt % or less, 10 wt % or less, 9 wt % or less, 8 wt % or less, 7 wt % or less, 6 wt % or less, 5 wt % or less, 4 wt % or less, 3 wt % or less, 2.5 wt % or less, 2 wt % or less, 1.5 wt % or less, 1 wt % or less, or 0.5 wt % or less.

The flow rate of the feedstock oil into the fiber conduit contactor is not particularly limited and, in some embodiments, may be, e.g., 5 to 100 ml/min, 5 to 75 ml/min, 10 to 75 ml/min, 10 to 60 ml/min, 15 to 60 ml/min, 20 to 60 ml/min, 25 to 55 ml/min, or 40 to 50 ml/min. The flow rate of the constrained phase is not particularly limited and, in some embodiments, may be, e.g., 5 to 100 ml/min, 10 to 75 ml/min, 15 to 60 ml/min, 15 to 50 ml/min, 20 to 45 ml/min, 20 to 40 ml/min, 25 to 40 ml/min, or 25 to 35 ml/min. The foregoing values are all based upon a conduit having a cross-sectional area of 20 cm² and it will be appreciated that these values may be appropriately scaled for a larger or smaller conduit.

The length of the fiber conduit contactor is not particularly limited and may be, e.g., 0.25 to 10 m, 0.5 to 5 m, 0.75 to 3 m, 1 to 2.5, or 1.5 to 2 m. The diameter or width of the fiber conduit contactor is likewise not particularly limited and may be, e.g., 0.5 cm to 3 m, 5 cm to 2.5 m, 10 cm to 2 m, 15 cm to 1.5 m, 20 cm to 1 m, 25 to 75 cm, 30 to 70 cm, 35 to 65 cm, 40 to 60 cm, 45 to 55 cm, or 50 cm.

The fiber materials for the extraction processes described herein may be, but are not limited to, cotton, jute, silk, treated or untreated minerals, metals, metal alloys, treated and untreated carbon allotropes, polymers, polymer blends, polymer composites, nanoparticle reinforced polymer, combinations thereof, and coated fibers thereof for corrosion resistance or chemical activity. In general, the fiber type is selected to match the desired constrained phase. For example, organophilic fibers may be used with a constrained phase that is substantially organic. This arrangement can, for example, be used to extract organic materials from water with organic liquids constrained to the fibers. Suitable treated or untreated minerals include, but are not limited to, glass, alkali resistant glass, E-CR glass, quartz, ceramic, basalt, combinations thereof, and coated fibers thereof for corrosion resistance or chemical activity. Suitable metals include, but are not limited to, iron, steel, stainless steel, nickel, copper, brass, lead, thallium, bismuth, indium, tin, zinc, cobalt, titanium, tungsten, nichrome, zirconium, chromium, vanadium, manganese, molybdenum, cadmium, tantalum, aluminum, anodized aluminum, magnesium, silver, gold, platinum, palladium, iridium, alloys thereof, and coated metals.

Suitable polymers include, but are not limited to, hydrophilic polymers, polar polymers, hydrophilic copolymers, polar copolymers, hydrophobic polymers/copolymers, non-polar polymers/copolymers, and combinations thereof, such as polysaccharides, polypeptides, polyacrylic acid, polyhydroxybutyrate, polymethacrylic acid, functionalized polystyrene (including but not limited to, sulfonated polystyrene and aminated polystyrene), nylon, polybenzimidazole, polyvinylidenedinitrile, polyvinylidene chloride and fluoride, polyphenylene sulfide, polyphenylene sulfone, polyethersulfone, polymelamine, polyvinyl chloride, polyvinyl acetate, polyvinyl alcohol, co-polyethylene-acrylic acid, polyethylene terephthalate, ethylene-vinyl alcohol copolymers, polyethylene, polychloroethylene, polypropylene, polybutadiene, polystyrene, polyphenol-formaldehyde, polyurea-formaldehyde, polynovolac, polycarbonate, polynorbornene, polyfluoroethylene, polyfluorochloroethylene, polyepoxy, polyepoxyvinylester, polyepoxynovolacvinylester, polyimide, polycyanurates, silicone, liquid crystal polymers, derivatives, composites, nanoparticle reinforced, and the like.

In some cases, fibers can be treated for wetting with preferred phases, to protect from corrosion by the process streams, and/or coated with a functional polymer. For instance, carbon fibers can be oxidized to improve wettability in aqueous streams and polymer fibers can display improved wettability in aqueous streams and/or be protected from corrosion by incorporation of sufficient functionality into the polymer, including but not limited to, hydroxyl, amino, acid, base, enzyme, or ether functionalities. In some cases, the fibers may include a chemical bound (i.e., immobilized) thereon to offer such functionalities. In some embodiments, the fibers may be ion exchange resins, including those suitable for hydroxyl, amino, acid, base or ether functionalities. In other cases, glass and other fibers can be coated with acid, base, or ionic liquid functional polymer. As an example, carbon or cotton fibers coated with an acid resistant polymer may be applicable for processing strong acid solutions. In some cases, fibers may include materials that are catalytic or extractive for particular processes. In some cases, the enzymatic groups may comprise the fibers to aid in particular reactions and/or extractions.

In some embodiments, all the fibers within a conduit contactor may be of the same material (i.e., have same core material and, if applicable, the same coating). In other cases, the fibers within a conduit contactor may include different types of materials. For example, a conduit contactor may include a set of polar fibers and a set of non-polar fibers. Other sets of varying materials for fibers may be considered. As noted above, the configuration of fibers (e.g., shape, size, number of filaments comprising a fiber, symmetry, asymmetry, etc.) within a conduit contactor may be the same or different for the processes described herein. Such variability in configuration may be in addition or alternative to a variation of materials among the fibers. In some embodiments, different types of fibers (i.e., fibers of different configurations and/or materials) may run side by side within a contactor with each set having their own respective inlet and/or outlet. In other cases, the different types of fibers may extend between the same inlet and outlet. In either embodiment the different types of fibers may be individually dispersed in the conduit contactor or, alternatively, each of the different fiber types may be arranged together. In any case, the use of different types of fibers may facilitate multiple separations, extractions, and/or reactions to be performed simultaneously in a conduit contactor from a singular or even a plurality of continuous phase streams. For example, in a case in which a conduit contactor is filled with multiple bundles of respectively different fiber types each connected to its own constrained phase fluid inlet and arranged off-angle, the bundles could be arranged for the continuous phase fluid to pass sequentially over the multiple fiber bundles with different materials extracted by or from each bundle. The fiber diameter is not particularly limited and may be, e.g., 5 to 150 μm, 10 to 100 μm, 12 to 75 μm, 15 to 60 μm, 17 to 50 μm, 20 to 45 μm, 20 to 35 μm, or 20 to 25 μm.

As used herein, the void fraction within the fiber conduit contactor is the total cross-sectional area of the fiber conduit contactor (where the cross section is taken perpendicular to the fiber conduit contactor longitudinal axis) minus the cross-sectional area of all of the fibers combined, divided by the total cross-sectional area. Thus, the void fraction represents the total percentage cross-sectional area available for fluid flow within the fiber conduit contactor. In some embodiments, the void fraction may be greater than 10%, greater than 20%, greater than 30%, greater than 40%, or greater than 50%. In some embodiments, the void fraction may be less than 50%, less than 45%, less than 40%, less than 35%, less than 30%, less than 25%, or less than 20%, less than 15%, less than 10%, or less than 5%. Depending on the size and shape of the fibers, a minimum possible void fraction may be, e.g., at least 10%, at least 20%, at least 30%, at least 40%, at least 50%, at least 60%, at least 70%, or at least 80%.

The temperature of the reaction may be, e.g., 15° C., 20° C., 25° C., 30° C., 35° C., 40° C., 45° C., 50° C., 55° C., 60° C., 65° C., 70° C., 75° C., 80° C., 85° C., 90° C., 95° C., 100° C., or greater than 100° C., or may range between any of the foregoing temperature values. In some embodiments, the reaction temperature is limited to the boiling point of the reactants, e.g., an alcohol within the caustic phase. However, operating the fiber conduit contactor at pressure allows the use of reaction temperatures in excess of the boiling points of the reactants and allows reaction temperatures to exceed 100° C. The pressure within the fiber conduit contactor is not particularly limited and may be, e.g., 5 to 75 psi, 10 to 60 psi, 15 to 40 psi, 20 to 30 psi, or 25 psi.

According to the method of the present disclosure, the feedstock oil (oil phase) is reacted with the caustic phase within the fiber conduit contactor to produce a purified oil phase and an extraction solution. The extraction solution includes FFAs and carotenoids removed from the feedstock oil. The purified oil phase and the extraction solution are received in the separator 24 as two distinct phases and separately removed therefrom.

Thereafter, the extraction solution is neutralized with acid in order to separate the FFAs and carotenoids from the other components of the solution (i.e., “the aqueous phase”). In this neutralization/acidification step, the acidifying agent is not particularly limited. In some embodiments, the acidifying agent includes a generally recognized as safe (“GRAS”) acid, such as phosphoric acid, acetic acid, or citric acid. In some embodiments, the acidifying agent may comprise hydrochloric acid or sulfuric acid. In some embodiments, the neutralization step reduces the pH of the aqueous phase to at most 7.0, at most 6.5, at most 6.0, at most 5.5, at most 5.0, at most 4.5, or at most 4.0. In some embodiments, the acidifying agent may be added to the extraction solution in the form of a powder or as an acidic solution. The pH of the acidic solution may be, e.g., less than 7.0, less than 6.5, less than 6.0, less than 5.5, less than 5.0, less than 4.5, less than 4.0, less than 3.0, or less than 2.0.

Once the extraction solution has been neutralized, the aqueous phase and the fatty acid phase form two separate layers. This is because the re-acidified FFAs are immiscible with the aqueous phase. It was herein found that, upon the neutralization/acidification, the carotenoids are relegated almost in entirety to the fatty acid phase. As such, the resultant fatty acid phase contains a high-concentration of carotenoids as compared with that of the original feedstock oil. In some embodiments, this separation may be facilitated by, e.g., centrifuging the mixture.

In some embodiments, the carotenoid content in the fatty acid phase, based on a total weight of the fatty acid phase, may be at least 50 ppm, at least 100 ppm, at least 200 ppm, at least 300 ppm, at least 400 ppm, at least 500 ppm, at least 600 ppm, at least 700 ppm, at least 800 ppm, at least 900 ppm, at least 1,000 ppm, at least 1,250 ppm, at least 1,500 ppm, at least 2,000 ppm, 50-5,000 ppm, 100-2,000 ppm, 200-1,000 ppm, 300-800 ppm, or 400-600 ppm. In some embodiments, a ratio of the carotenoid content in the fatty acid phase to the carotenoid content in the feedstock oil is at least 1.5, at least 2, at least 2.5, at least 3, at least 4, at least 5, at least 6, at least 7, at least 8, at least 9, or at least 10.

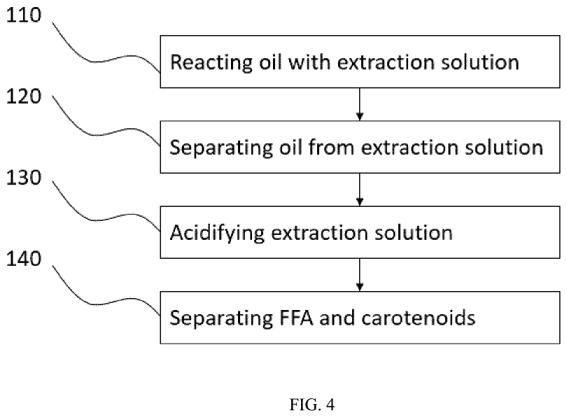

With reference to FIG. 4, a method 100 for producing a carotenoid enriched fatty acid composition according to one or more embodiments is illustrated. In a step 110, an oil containing FFAs and carotenoids is brought into contact with an extraction solution. The oil and extraction solution may be as described above. Step 110 may involve introducing each of the oil and the extraction solution into a fiber conduit contactor, such as that described above. At step 120, the extraction solution is separated from the oil (or the oil is separated from the extraction solution), wherein at least a portion of the FFAs and carotenoids from the oil have been extracted into the extraction solution. Step 120 may employ a separator in communication with a downstream end of the fiber conduit contactor. At step 130, the extraction solution (including FFAs and carotenoids) is acidified with an acid, such as any of those described above. In one or more embodiments, step 130 may be conducted in a fiber conduit contactor, which may be the same or different from the fiber conduit contactor employed in step 110. Step 130 may include agitating the mixture of extraction solution and acid, e.g., by shaking or using an agitation device, such as an impeller, a magnetic stirrer, a shaker, or the like. In step 140, the FFAs and carotenoids are separated as an organic phase from the acidified extraction solution, which is an aqueous phase. Steps 130 and 140 may utilize, e.g., a separatory funnel. The FFAs and carotenoids obtained in step 140 represents a valuable product that may be, e.g., beneficially added to an animal feed product, such as DDGs, to increase the fat (energy) and carotenoid levels. In the case of DDGs, this enrichment with the fatty acid phase allows for an increased removal of fats from the DDGs at the original extraction phase (i.e., after distillation) without concerns that the DDGs will be too low in nutrition.

### EXAMPLE 1

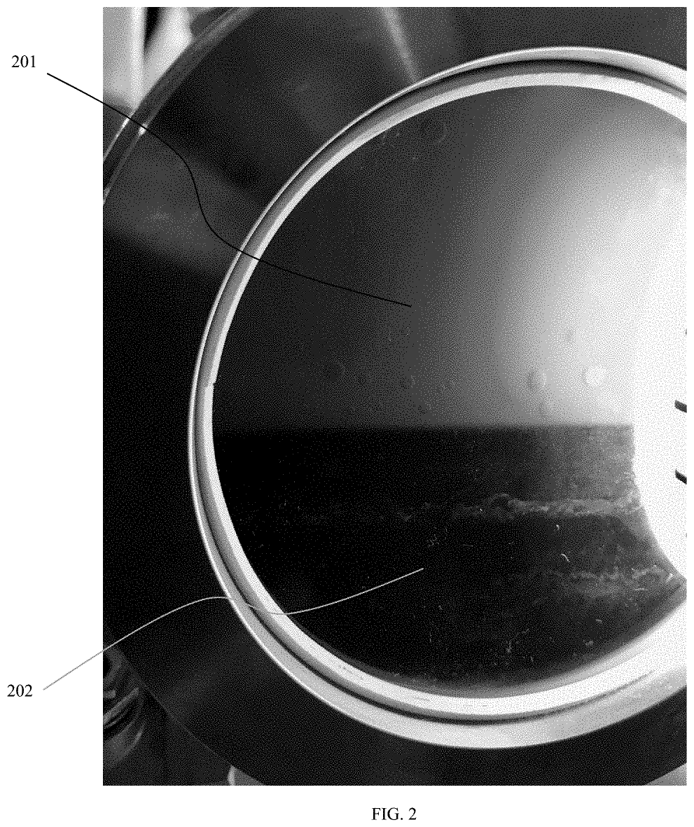

A fiber conduit contactor was prepared having a 1″ diameter conduit, packed with 50 μm fibers, and a void fraction of approximately 50%. A constrained phase including water, ethanol and 4 wt % sodium hydroxide was introduced to the fibers at a rate of 75 ml/min. Distiller's corn oil containing 14% FFA by weight was then introduced as a continuous phase at a rate of 125 ml/min. The temperature of the fiber conduit contactor was set at 65° C. and 0 psi pressure was recorded. The resultant two-phase composition is shown in FIG. 2. Carotenoid partitioning can be visualized via the now dark red carotenoid enriched aqueous phase containing fatty acid soap in the bottom phase 202 of FIG. 2, while the neutralized DCO is in the top phase 201.

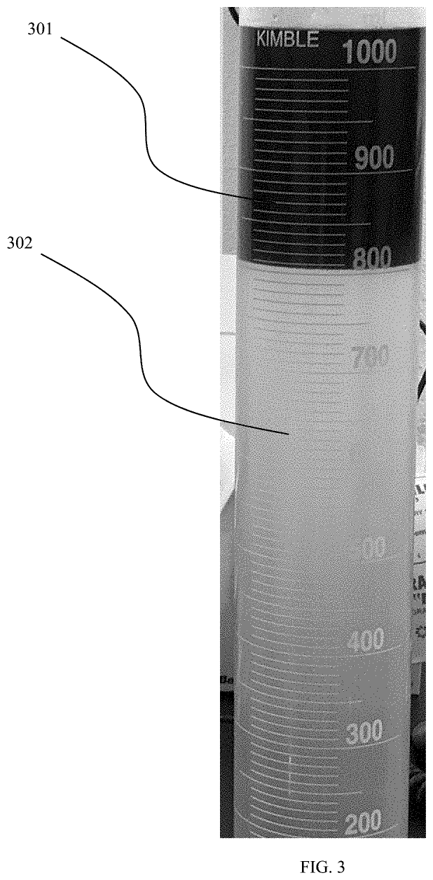

About 1000 ml of the aqueous phase was added to a separatory funnel with about 20 ml of 85% phosphoric acid and shaken. Within 5 mins, the FFAs plus carotenoids were collected as the top phase 301 and the aqueous phase was collected as the bottom phase 302. The resultant two-phase composition is shown in FIG. 3. The FFA phase separated from the aqueous phase and analyzed using HPLC. The results are shown in Table 1 below. The total carotenoid concentration in the FFAs was 4.7 times greater than in the neutralized DCO and 3.2 times greater than in the crude DCO starting material.

TABLE 1
Partitioning of carotenoids between FFA's and neutralized DCO

| Analyte (mg/Kg) | Crude DCO | Neutral DCO | FFA |
|---|---|---|---|
| Total carotenoids | 789 | 544 | 2558 |
| α-carotene | 17 | 15 | 19 |
| β-carotene | 46 | 39 | 89 |
| Canthaxanthin | 66 | 23 | 360 |
| β-cryptoxanthin | 110 | 54 | 230 |
| Lutein | 190 | 120 | 750 |
| Lycopene | ND | ND | ND |
| Phytoene | 67 | 93 | 110 |
| Violaxanthin | ND | ND | ND |
| Zeaxanthin | 310 | 200 | 1000 |

A method for producing a carotenoid enriched fatty acid composition has been described herein. The method includes: reacting an oil comprising free fatty acids and carotenoids with a basic solution; withdrawing, separately from the oil, an extraction solution comprising at least a portion of the free fatty acids, at least a portion of the carotenoids, and the basic solution; acidifying the extraction solution to produce an aqueous phase and a fatty acid phase, the fatty acid phase comprising the free fatty acids and the carotenoids of the extraction solution; and separating the fatty acid phase from the aqueous phase.

The method may include any combination of the following features:
The acidifying step comprises adding at least one acid selected from the group consisting of phosphoric acid, acetic acid, hydrochloric acid, sulfuric acid, and citric acid to the caustic phase;
The acid comprises phosphoric acid;
The separating step comprises centrifuging the acidified extraction solution;
A concentration of carotenoids in the oil, based on a total weight of the oil, is from 50 to 5000 ppm; and
A concentration of carotenoids in the fatty acid phase, based on a total weight of the fatty acid phase, is at least 1.5 times the concentration of carotenoids in the oil.

A method for producing a carotenoid enriched fatty acid composition using a conduit contactor having a plurality of fibers disposed therein has been described herein. The method includes: introducing a first stream comprising a solvent and a caustic reagent into the conduit contactor proximate the plurality of fibers, wherein a downstream end thereof is disposed proximate a collection vessel, and wherein the first stream has a pH of greater than 7; introducing a second stream containing an oil comprising free fatty acids and carotenoids into the conduit contactor proximate the plurality of fibers; reacting the first and second streams to produce a caustic phase and a purified oil phase, wherein the caustic phase comprises the solvent, the caustic reagent, and at least a portion of the free fatty acids and at least a portion of the carotenoids from the second stream; receiving the caustic phase and the purified oil phase in the collection vessel; withdrawing separately the caustic phase from the collection vessel; acidifying the caustic phase; and separating a fatty acid phase from the acidified caustic phase, wherein the fatty acid phase comprises free fatty acids and carotenoids.

The method may include any combination of the following features:
The acidifying step comprises adding at least one acid selected from the group consisting of phosphoric acid, acetic acid, hydrochloric acid, sulfuric acid, and citric acid to the caustic phase;
The acid comprises phosphoric acid;
The separating step comprises centrifuging the acidified caustic phase;
The solvent comprises at least one of water or alcohol;
A concentration of carotenoids in the second stream, based on a total weight of the second stream, is from 50 to 5000 ppm;
A concentration of carotenoids in the fatty acid phase, based on a total weight of the fatty acid phase, is at least 1.5 times the concentration of carotenoids in the second stream;
The first stream is constrained to surfaces of the plurality of fibers and the second stream forms a continuous phase in interstitial spaces between the plurality of fibers; and
The second stream is constrained to surfaces of the plurality of fibers and the first stream forms a continuous phase in interstitial spaces between the plurality of fibers.

A system for producing a carotenoid enriched fatty acid composition has been described herein. The system includes: a fiber conduit contactor comprising: a conduit having a hollow interior, a first open end, and a second open end opposite the first open end; a collection vessel in fluid communication with and proximate the second open end; and a plurality of fibers disposed within the conduit; a first stream supply configured to introduce a first stream comprising a basic solution into the conduit and onto the fibers; a second stream supply configured to introduce a second stream comprising an oil comprising free fatty acids and carotenoids into the conduit such that the second stream contacts the first stream; an acidification vessel configured to receive a reaction product of the first and second streams, the reaction product comprising the basic solution, at least a portion of the free fatty acids, and at least a portion of the carotenoids; and a third stream supply configured to introduce a third stream comprising an acid into the acidification vessel.

The system may include any combination of the following features:
The acid comprises at least one acid selected from the group consisting of phosphoric acid, acetic acid, hydrochloric acid, sulfuric acid, and citric acid;
The acidification vessel includes an agitation device;
The first stream supply is closer to the first open end than the second stream supply; and
The second stream comprises distiller's corn oil and has a concentration of carotenoids, based on a total weight of the second stream, of from 50 to 5000 ppm.

It is understood that variations may be made in the foregoing without departing from the scope of the present disclosure. In several example embodiments, the elements and teachings of the various illustrative example embodiments may be combined in whole or in part in some or all of the illustrative example embodiments. In addition, one or more of the elements and teachings of the various illustrative example embodiments may be omitted, at least in part, and/or combined, at least in part, with one or more of the other elements and teachings of the various illustrative embodiments.

1. (canceled)

2. (canceled)

3. (canceled)

4. (canceled)

5. (canceled)

6. (canceled)

7. A method for producing a carotenoid enriched fatty acid composition using a conduit contactor having a plurality of fibers disposed therein, the method comprising:
introducing a first stream comprising a solvent and a caustic reagent into the conduit contactor proximate the plurality of fibers, wherein a downstream end thereof is disposed proximate a collection vessel, and wherein the first stream has a pH of greater than 7;
introducing a second stream containing an oil comprising free fatty acids and carotenoids into the conduit contactor proximate the plurality of fibers;
reacting the first and second streams to produce a caustic phase and a purified oil phase, wherein the caustic phase comprises the solvent, the caustic reagent, and at least a portion of the free fatty acids and at least a portion of the carotenoids from the second stream;
receiving the caustic phase and the purified oil phase in the collection vessel;
withdrawing separately the caustic phase from the collection vessel;
acidifying the caustic phase; and
separating a fatty acid phase from the acidified caustic phase, wherein the fatty acid phase comprises free fatty acids and carotenoids.

8. The method according to claim 7, wherein the acidifying step comprises adding at least one acid selected from the group consisting of phosphoric acid, acetic acid, hydrochloric acid, sulfuric acid, and citric acid to the caustic phase.

9. The method according to claim 8, wherein the acid comprises phosphoric acid.

10. The method according to claim 7, wherein the separating step comprises centrifuging the acidified caustic phase.

11. The method according to claim 7, wherein the solvent comprises at least one of water or alcohol.

12. The method according to claim 7, wherein a concentration of carotenoids in the second stream, based on a total weight of the second stream, is from 50 to 5000 ppm.

13. The method according to claim 12, wherein a concentration of carotenoids in the fatty acid phase, based on a total weight of the fatty acid phase, is at least 1.5 times the concentration of carotenoids in the second stream.

14. The method according to claim 7, wherein the first stream is constrained to surfaces of the plurality of fibers and the second stream forms a continuous phase in interstitial spaces between the plurality of fibers.

15. The method according to claim 7, wherein the second stream is constrained to surfaces of the plurality of fibers and the first stream forms a continuous phase in interstitial spaces between the plurality of fibers.

16. A system for producing a carotenoid enriched fatty acid composition, the system comprising:
a fiber conduit contactor comprising:
a conduit having a hollow interior, a first open end, and a second open end opposite the first open end;
a collection vessel in fluid communication with and proximate the second open end; and
a plurality of fibers disposed within the conduit;
a first stream supply configured to introduce a first stream comprising a basic solution into the conduit and onto the fibers;
a second stream supply configured to introduce a second stream comprising an oil comprising free fatty acids and carotenoids into the conduit such that the second stream contacts the first stream;
an acidification vessel configured to receive a reaction product of the first and second streams, the reaction product comprising the basic solution, at least a portion of the free fatty acids, and at least a portion of the carotenoids; and
a third stream supply configured to introduce a third stream comprising an acid into the acidification vessel.

17. The system according to claim 16, wherein the acid comprises at least one acid selected from the group consisting of phosphoric acid, acetic acid, hydrochloric acid, sulfuric acid, and citric acid.

18. The system according to claim 16, wherein the acidification vessel includes an agitation device.

19. The system according to claim 16, wherein the first stream supply is closer to the first open end than the second stream supply.

20. The system according to claim 16, wherein the second stream comprises distiller's corn oil and has a concentration of carotenoids, based on a total weight of the second stream, of from 50 to 5000 ppm.
